(19) United States
(12) Patent Application Publication
(10) Pub. No.: US 2017/0348594 A1
(43) Pub. Date: Dec. 7, 2017

(54) Device, System, and Method for Motion Feedback Controller

(71) Applicant: Wind River Systems, Inc., Alameda, CA (US)

(72) Inventor: Mirel Tudorel LAZAR, Alameda, CA (US)

(21) Appl. No.: 15/171,645

(22) Filed: Jun. 2, 2016

(51) Int. Cl. A63F 13/24; G06F 3/01; A63F 13/825; A63F 13/803; A63F 13/54; A63F 13/28; A63F 13/23; G06T 19/00; A63F 13/20

(52) U.S. Cl. CPC A63F 13/24; G06T 19/006; G06F 3/016; A63F 13/825; A63F 13/20; A63F 13/54; A63F 13/28; A63F 13/23; A63F 13/803

(57) ABSTRACT

A device, system, and method uses universal serial bus (USB) signals to determine motion data. The method performed by a feedback controller includes receiving an input command from an input controller, the input command corresponding to a command entered by a user, the input controller utilizing a USB connection with the feedback controller. The method includes determining motion data corresponding to the input command, the motion data indicating a sensory action to be performed by a motion platform, the motion platform connected to the feedback controller. The method includes transmitting the motion data from the feedback controller to the motion platform.

### BACKGROUND INFORMATION

A simulator enables a virtual environment to be provided to a user to experience the virtual environment through at least one sense. For example, the simulator may provide a visual and auditory experience with the virtual environment. The visual and auditory experience may be refined such that the virtual environment becomes more realistic. For example, the graphics may be shown on a display device in three dimensions to mimic how the user sees objects in reality. In another example, audio may be played on an audio output device using a surround sound process rather than originating from a single direction. The visual and auditory experience may also be synchronized such that a graphic at a particular location may have an associated sound that is played to seem to originate from that particular location.

The simulator may also utilize further types of experiences in providing the virtual environment. Specifically, the simulator may include a sensory experience with the virtual environment. In a first example, an input controller (e.g., gaming controller) may include a vibrating feature (e.g., a rumble pack) that triggers when a particular action is registered. In a second example, a motion simulator or a motion platform may simulate physical sensory aspects (e.g., driving chair).

With particular regard to a motion platform, the device (e.g., a host) providing the virtual environment, an input controller receiving commands from the user, and the motion platform may utilize predetermined customized signals, commands, inputs, data, etc. (that may also be proprietary) to generate the sensory experience. For example, a car driving simulator may be packaged with the software and the hardware that enables the car driving virtual environment to be created and provided to the user. However, the car driving simulator and the associated signals are highly specialized and the hardware components associated with the simulator must be used or the simulator may be incapable of creating the virtual environment as intended. The software may also be required to be updated (if available) or risk the simulator again being incapable of creating the virtual environment as intended.

### SUMMARY OF THE INVENTION

The exemplary embodiments are directed to a method comprising: receiving, by a feedback controller, an input command from an input controller, the input command corresponding to a command entered by a user, the input controller utilizing a universal serial bus (USB) connection with the feedback controller; determining, by the feedback controller, motion data corresponding to the input command, the motion data indicating a sensory action to be performed by a motion platform, the motion platform connected to the feedback controller; and transmitting the motion data from the feedback controller to the motion platform.

The exemplary embodiments are directed to a feedback controller comprising: an input/output (I/O) device receiving an input command from an input controller, the input command corresponding to a command entered by a user, the input controller utilizing a universal serial bus (USB) connection with the feedback controller; and a processor determining motion data corresponding to the input command, the motion data indicating a sensory action to be performed by a motion platform, the motion platform connected to the feedback controller, wherein the I/O device transmits the motion data from the feedback controller to the motion platform.

The exemplary embodiments are directed to a non-transitory computer readable storage medium with an executable program stored thereon, wherein the program instructs a microprocessor to perform operations comprising: receiving an input command from an input controller, the input command corresponding to a command entered by a user, the input controller utilizing a universal serial bus (USB) connection with a feedback controller; determining motion data corresponding to the input command, the motion data indicating a sensory action to be performed by a motion platform, the motion platform connected to the feedback controller; and transmitting the motion data from the feedback controller to the motion platform.

### BRIEF DESCRIPTION OF THE DRAWINGS

FIG. 1 shows a system for motion feedback according to the exemplary embodiments.

FIG. 2 shows a feedback controller of FIG. 1 according to the exemplary embodiments.

FIG. 3 shows a workflow for generating motion commands according to the exemplary embodiments.

FIG. 4 shows a method for generating motion commands according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for a motion feedback controller configured to convert inputs into signals associated with a motion platform. Specifically, the exemplary embodiments relate to a mechanism of the feedback controller generating the signals converted from human interface device (HID) events from a universal serial bus (USB) input controller. The feedback controller may provide the signals to a motion platform that converts the signals to a corresponding action to be performed. Therefore, the exemplary embodiments provide a mechanism by which any USB input controller that provides HID events may be used in conjunction with a motion platform without the use of specialized signals and/or specialized software/hardware.

The exemplary embodiments provide a mechanism in which USB HID events between a host and an input controller are leveraged for use with a motion platform. Specifically, the host may be a console in which the virtual environment is generated and the device may be a motion platform or motion simulator. Thus, the USB HID events may be leveraged for the purpose of controlling the motion platform and extend the HID events received from an input controller from a classical sense to a motion feedback controller. Accordingly, the exemplary embodiments provide a manner in which the need for shared data (e.g., specified data) between the host generating the virtual environment and the motion platform is eliminated as only existing USB HID data exchange is required. Therefore, through the feedback controller according to the exemplary embodiments, any combination using an input controller, a motion platform, and a host (i.e., device generating the virtual environment) may be used where the devices are capable of accommodating USB connections and data exchange. That is, unlike conventional approaches, the exemplary embodiments are not limited to custom or specialized data shared between the simulation application and the motion platform. The use of the USB HID message exchange between the motion platform and the input controller enables the use of commercial off the shelf (COTS) input controllers and motion platforms that implement the USB HID standard for use with a motion platform.

It should be noted that the exemplary embodiments relate to the host being a console or centralized device that renders the virtual environment. The use of the USB components may also relate to platforms associated with personal computers. However, the exemplary embodiments may incorporate embodiments utilizing personal computers and may also extend the implementation to simulation platforms other than personal computers including the latest generation of game consoles or tablets to be used as simulation platforms.

It should also be noted that the exemplary embodiments are described herein with regard to utilizing the HID events of a USB input controller for conversion into signals to a motion platform. However, the use of the motion platform is only exemplary. The motion platform may represent any destination in which the signals converted from the HID events of the USB input controller are to be forwarded.

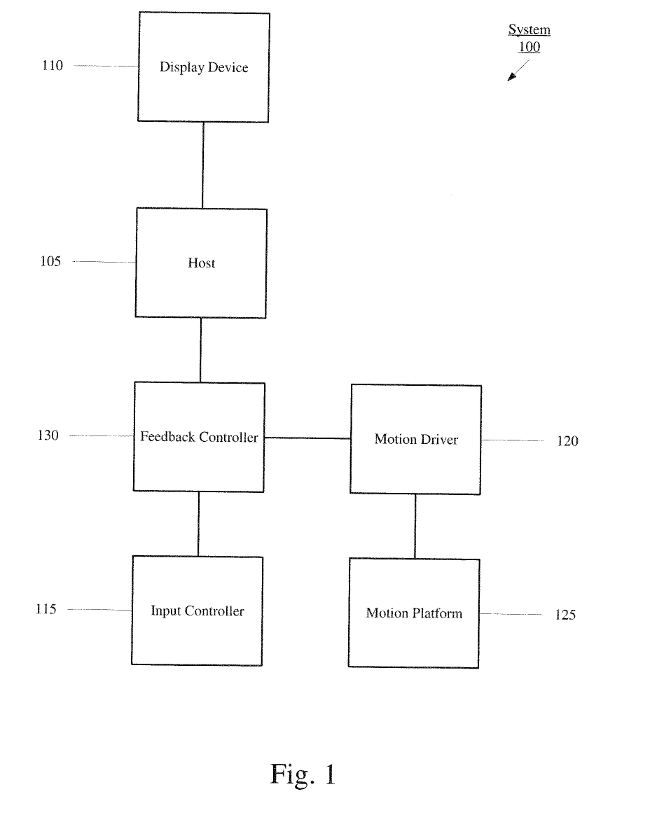

FIG. 1 shows a system 100 for motion feedback according to the exemplary embodiments. The system 100 may include a plurality of components including a host 105, a display device 110, an input controller 115, a motion driver 120 controlling a motion platform 125, and a feedback controller 130. As will be described in further detail below, the host 105, the display device 110, the input controller 115, the motion driver 120, and the motion platform 125 may provide a plurality of functionalities associated with motion simulation. The feedback controller 130 according to the exemplary embodiments is used to relay the HID events from the input controller 115 to the host 105 and return outputs from the host 105 back to the input controller 115. The feedback controller 125 according to the exemplary embodiments further interpret the HID events from the input controller 115 and/or the outputs from the host 125 to compute motion data for driving the motion driver 120 which in turn controls the motion platform 120.

The host 105 may represent any simulation platform that generates or renders the virtual environment. The exemplary embodiments relate to a user controlled virtual environment in which a desired location and/or action is received from the user from which the host 105 renders the virtual environment. However, it should be noted that the exemplary embodiments may also be utilized for rendering the virtual environment in instances where the user does not provide the input for a desired location/action. As noted above, the host 105 may be any computing device such as a personal computer, a console (e.g., a gaming console), etc. Accordingly, the host 105 may include a plurality of components associated with performing this functionality such as a processor, a memory, a transceiver, an I/O device, etc. The host 105 may therefore generate the virtual environment and update the virtual environment based upon commands that are received in manipulating the virtual environment. For example, the visual display associated with the virtual environment may be updated based upon the command.

The display device 110 may represent any visual component that shows the virtual environment to the user. The display device 110 may utilize a wired or wireless connection to receive visual data from the host 105. For example, the display device 110 may be a liquid crystal display (LCD) screen receiving the visual data from the host 105. In this manner, a first sensory perception of the virtual environment may be provided to the user. The display device 110 may also represent any sound component that plays audio associated with the virtual environment to the user. The sound component may be an integrated component of the display device 110 or may be a separate component with sub-components (e.g., speakers) connected thereto. In this manner, a second sensory perception of the virtual environment may be provided to the user.

The input controller 115 may be any component that enables the user to enter inputs for the desired command in controlling the virtual environment. For example, if the host 105 is a gaming console, the input controller 115 may be a gaming controller including at least one of a directional pad, a plurality of buttons, a joystick, etc. In another example, if the host 105 is for a vehicle driving virtual environment (e.g., a car), the input controller 115 may be a vehicle controller (e.g., a steering wheel with a seat and appropriate pedals). In a further example, if the host 105 is for a flight simulator, the input controller 115 may be a plane controller (e.g., a flight panel).

The input controller 115 may utilize a USB connector in which to establish a connection to the host 105. The USB connector of the input controller 115 may be a wired connection or a wireless connection. For example, with a wired connection, the USB connector may have a printed circuit board (PCB) housed within the input controller 115 in which a wire is coupled (e.g., soldered) and an opposite end of the wire may have a conventional USB connector end (e.g., to be received by the host 105). In another example, with a wireless connection, the USB connector may include a transceiver included in the input controller 115 that communicates with a further modular transceiver having a USB connector end that is connected to, for example, the host 105.

The USB connector of the input controller 115 may enable conventional USB signals to be exchanged with the host 105. For example, in the above noted example of the input controller 115 being a gaming controller, more particularly one including a joystick, an input event from the user may include a USB HID input report along the x-axis (e.g., registering horizontal movements), a USB HID input report along the y-axis (e.g., registering vertical movements), and a USB HID input report along the z-axis (e.g., depressing the joystick). The further components of the input controller such as a directional pad may also register the x-axis and y-axis USB HID input reports. In this manner, the input controller 115 may generate and exchange conventional USB signals with the host 105.

As illustrated, the input controller 115 may be connected to the host 105 through a direct or indirect connection. As shown in the system 100, there may be a direct connection from the input controller 115 to the feedback controller 130 in which the feedback controller 130 is connected to the host 105. As will be described in further detail below, the system 100 may also represent a signal pathway such that the input controller 115 may instead be connected directly to the host 105 with the signal pathway being defined as shown in the system 100.

The motion driver 120 may represent a device driver associated with the motion platform 125. Those skilled in the art will understand that the motion driver 120 being a device driver may operate or control the motion platform 125 through a software interface for the motion platform 125 to allow the host 105 to access the functionalities provided by the motion platform 125 without a requirement of specific details of the hardware being used. Thus, when the host 105 invokes a routine in the motion driver 120, the motion driver 120 may issue motion data to the motion platform 125 for corresponding actions to be performed. Accordingly, the motion driver 120 may provide a translation functionality between the host 105 and the motion platform 125. For example, a user may provide a command via the input controller 115. As will be described in further detail below, the feedback controller 120 may receive the command, interpret the signal associated with the command, and determine the corresponding motion data to be forwarded to the motion driver 120 which in turn transmits a corresponding command to the motion platform 125 to perform a motion action.

The motion platform 125 may be the physical simulator for the virtual environment. Specifically, the motion platform 125 may create effects of being present in the virtual environment such as in a moving vehicle. The effects created by the motion platform 125 may be synchronous with the visual display on the display device 110 and/or audio outputs to provide a tactile element to the simulation of the virtual environment. In this manner, a third sensory perception of the virtual environment may be provided to the user. The effects may move an occupant compartment in which the user is located to convey changes in orientation and the simulation effect of false gravitational forces. Thus, when the host 105 generates a virtual driving environment, the effects may create a sense to the user of experiencing kinematic changes in position, velocity, and/or acceleration.

The motion platform 125 may be capable of providing movement on a plurality of different degrees of freedom that define the independent parameters of a configuration. Specifically, the motion platform 125 may be capable of utilizing up to six degrees of freedom: three rotational degrees of freedom (i.e., roll, pitch, and yaw) and three translational or linear degrees of freedom (i.e., surge, heave, and sway). For example, with objects experiencing three dimensional movements (e.g., a ship or an airplane), the motion may include heaving (e.g., moving up or down), swaying (moving left or right), surging (e.g., moving forward and backward), pitching (e.g., tilting forward or backward), yawing (e.g., swiveling left or right), and rolling (e.g., pivoting side to side).

The feedback controller 130 may be an intermediary component configured to forward signals as well as interpret commands from the input controller 115 and/or the host 105 to generate instructions for the motion driver 120 to forward to the motion platform 125. The feedback controller may specifically be an intermediary component along a signal pathway between the host 105, the input controller 115, and the motion driver 120. As illustrated in the system 100, each of the host 105, the input controller 115, and the motion driver 120 has a signal exchange pathway with the feedback controller 130. Therefore, all signals exchanged between the host 105, the input controller 115, and the motion driver 120 passes through the feedback controller 130. In this manner, the feedback controller 130 has access to the signals being exchanged.

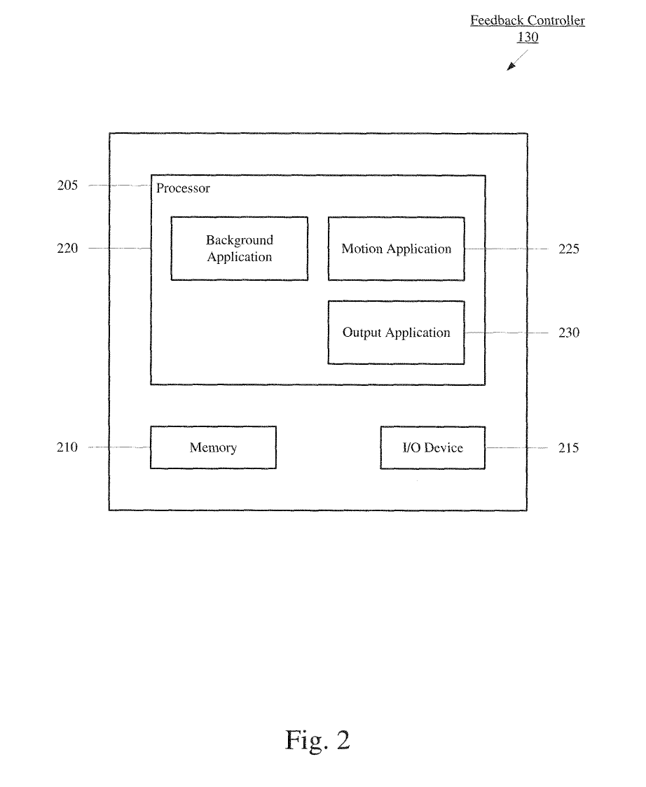

FIG. 2 shows the feedback controller 130 of FIG. 1 according to the exemplary embodiments. The feedback controller 130 may be embodied in a variety of manners. In a first exemplary embodiment, the feedback controller 130 may be incorporated with the host 105. For example, the feedback controller 130 may be a software application executed by the processor of the host 105 that receives the signals from the input controller 115 and outputs signals bound for the input controller 115 from a further application executed by the host 105. In another example, the feedback controller 130 may be a component integrated onto a PCB of the host 105. When the feedback controller 130 is incorporated with the host 105, the input controller 115 may establish a connection directly with the host 105. The internal circuitry may enable signals from the input controller 115 to pass through the feedback controller 130. In a second exemplary embodiment, the feedback controller 130 may be a modular component connected to the host 105. For example, the feedback controller 130 may include a separate set of components substantially similar to the host 105 in performing its functionality that are housed in a housing of the feedback controller 130. When the feedback controller 130 is a modular component, the input controller 115 may establish a direct or indirect connection with the feedback controller 130. In a first example, the feedback controller 130 may have established a connection with the host 105. The feedback controller 130 may also establish a connection with the input controller 115. Accordingly, the signal pathway between the host 105 and the input controller 115 may include the feedback controller 130. In a second example, the feedback controller 130 may have established a connection with the host 105. The input controller 115 may also establish a connection with the host 105. Accordingly, the system 100 may include a configuration such that the signal pathway between the host 105 and the input controller 115 includes the feedback controller 130. It is noted that the motion driver 120 is configured to receive signals from the feedback controller 130. Thus, the motion driver 120 may establish a direct connection to the feedback controller 130 or the system 100 may include a configuration in which signals from the feedback controller 130 may be transmitted to the motion driver 120.

As noted above, the feedback controller 130 may include a plurality of different components. As illustrated in FIG. 2, the feedback controller 130 may include at least a processor 205, a memory 210, and a input/output (I/O) device 215. The processor 205, the memory 210, and the I/O device 215 may perform conventional functionalities. For example, the processor 205 may perform processing functionalities that will be described in further detail below. The memory 210 may perform storage functionalities such as storing data associated with the processes performed by the processor 205 and data that is received and to be transmitted. The I/O device 215 may represent any input/output component that performs functionalities associated therewith. For example, the I/O device 215 may be used for a forwarding functionality.

The processor 205 may be configured to execute a plurality of applications of the feedback controller 130. For example, the processor 205 may execute a background application 220, a motion application 225, and an output application 230. Initially, it is noted that the applications executed by the processor 205 are only exemplary. For example, the functionalities described for the applications may also be represented as a separate module, a separately incorporated component of the feedback controller 130 (e.g., an integrated circuit with or without firmware), or a modular component coupled to the feedback controller 130. The functionality may also be distributed throughout multiple components of the feedback controller 130.

The feedback controller 130 may include a plurality of different functionalities in its intermediary role along the signal pathway that utilize the background application 220, the motion application 225, and the output application 230. In a first exemplary functionality, the feedback controller 130 may provide a forwarding functionality. Specifically, the output application 230 may provide this functionality. The forwarding functionality may relate to the intermediary position of the feedback controller 130 along the signal pathway. Specifically, when the input controller 115 receives a command from the user, the input controller 115 generates a corresponding signal to be transmitted to the host 105. With the feedback controller 130 disposed between the host 105 and the input controller 115 in the signal pathway, the feedback controller 130 may perform the forwarding functionality such that the signal of the command received on the input controller 115 is properly received by the host 105. The forwarding functionality may also be performed from an output signal of the host 105 to the input controller 115. For example, the input controller 115 may include a different sensory component (e.g., a rumble pack) that is triggered from the output signal from the host 105 being received. That is, the host 105 may receive the signal of the command that results in the updating of the virtual environment for the display device 110 as well as the output signal being generated. Again, as the feedback controller 130 is disposed between the host 105 and the input controller 115 in the signal pathway, the feedback controller 130 may perform the forwarding functionality for the output signal from the host 105 to the input controller 115.

In a second exemplary functionality of the feedback controller 130, the feedback controller 130 may utilize the signals corresponding to the command received on the input controller 115 to determine the actions to be performed by the motion platform 125 (via corresponding signals transmitted to the motion driver 120). Specifically, the motion application 225 may perform this functionality. According to the exemplary embodiments, the feedback controller 130 may interpret the USB signals from the input controller 115 to determine a corresponding action to be performed by the motion platform 125 to provide the sensory effects for the user. The feedback controller 130 may receive background data from the host 105 and the motion driver 120 to establish the virtual environment as well as type of sensory experience is being provided by the motion platform 125. Specifically, this functionality may be performed by the background application 220. Accordingly, the feedback controller 130 may be configured to provide the appropriate motion data to the motion driver 120 based upon the input commands from the input controller 115 and/or output signals from the host 105.

In a first specific example, as described above with regard to input commands from the input controller 115, the input controller 115 may include a joystick in which USB HID input reports may be provided to the host 105. Specifically, the USB HID input report along the x-axis may be denoted as a “wheelX” input command; the USB HID input report along the y-axis may be denoted as a “wheely” input command; and the USB HID input report along the z-axis may be denoted as a “wheelz” input command. The input controller 115 may package an overall USB HIB input report for transmission to the host 105. When the configuration of the system 100 includes the feedback controller 130 in the signal pathway between the host 105 and the input controller 115, the feedback controller 130 may initially receive the overall USB HID input report from the input controller 115. The feedback controller 130 may forward the overall USB HID input report to the host 105. The feedback controller 130 may also utilize the overall USB HID input report to generate the corresponding motion data to be transmitted to the motion driver 120. For example, the wheelX input command may be used to determine an update to a roll axis motion on the motion platform 125; the wheelY input command may be used to determine an update to a pitch axis motion on the motion platform 125; and the wheelZ input command may be used to determine an update to a yaw axis motion on the motion platform 125. The corresponding motion data for the updates to the motion platform 125 may be transmitted from the feedback controller 130 to the motion driver 120 via the output application 230. The motion driver 120 may accordingly translate the motion data to command the motion platform to perform the corresponding actions. It is again noted that the input controller 115 may utilize conventional USB event signals which are interpreted by the feedback controller 130 in performing its functionality of generating corresponding motion data for the motion driver 120.

In a second specific example, as described above with regard to output signals from the host 105, the host 105 may receive the USB HID input report to determine how the virtual environment is to be updated. For example, the visual and audio component may be updated and provided on the display device 110. If properly configured, the host 105 may also generate output signals bound for the input controller 115. For example, the input controller 115 may include a further sensory component that responds to the input commands received thereon. With the feedback controller 130 being an intermediary component along the signal pathway, the feedback controller 130 may receive the output signals from the host 105. Initially, the feedback controller 130 may forward the output signals from the host 105 to the input controller 115. The input controller 115 may receive the output signals and perform the sensory action associated therewith. Specifically, the output signals may be for a force feedback event. The feedback controller 130 may also utilize the output signal to determine any further updates to the degrees of freedom on the motion platform 125. For example, with the force feedback event, the force types and parameters may be determined to update at least one of the roll axis, the pitch axis, and the yaw axis. Accordingly, the feedback controller 130 may generate further motion data for the motion driver 120 via the output application 230. In this manner, the feedback controller 130 generates the further motion data corresponding to the output signal. It is again noted that the host 105 may also utilize conventional USB event signals which are interpreted by the feedback controller 130 in performing its functionality of generating corresponding motion data for the motion driver 120.

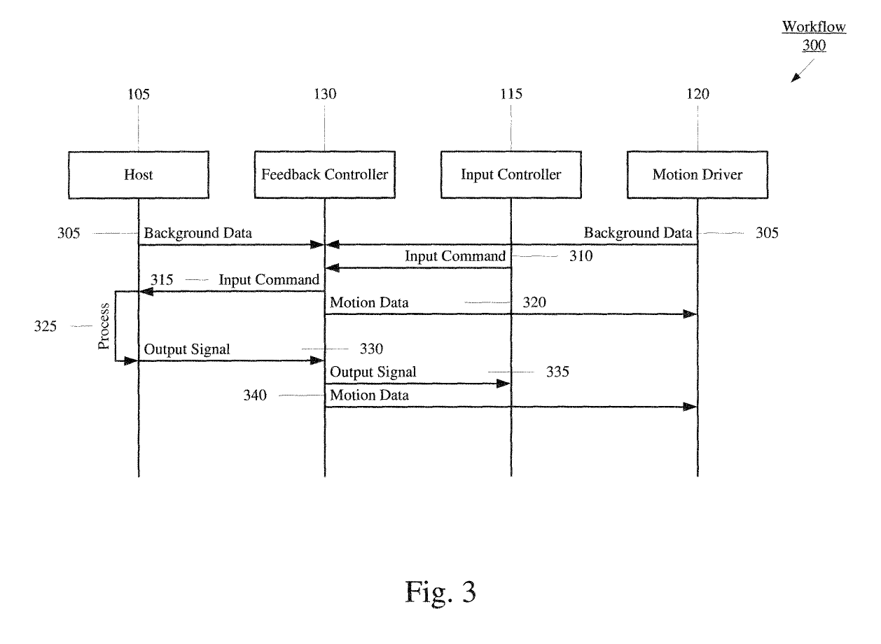

FIG. 3 shows a workflow 300 for generating motion commands according to the exemplary embodiments. The workflow 300 includes the host 105, the input controller 115, the motion driver 120, and the feedback controller 130. As described above, the feedback controller 130 may be an intermediary component. Accordingly, the workflow 300 illustrates the results associated with the feedback controller 130 being positioned in an intermediary way along the signal pathway.

Initially, background data 305 is provided by the host 105 and the motion driver 120. Specifically, once the feedback controller 130 has established a connection with the host 105 and has been configured therebetween, the feedback controller 130 may determine the virtual environment that the host 105 is attempted to generate and update. Once the input controller 115 has established a connection with the host 105 and/or the feedback controller 130 and has been configured therebetween, the feedback controller 130 may determine the manner in which the motion platform 125 will provide the sensory aspect for the virtual environment.

When the motion platform 125 and the host 105 have been activated for the virtual environment to be rendered, the user may begin to enter input commands 310. For example, the input commands 310 may be USB HID input reports. The input commands 310 may relate how the user wishes to manipulate the virtual environment. For example, for a vehicle driving virtual environment, the input commands 310 may relate to how the vehicle is to be driven based upon the environment in which the vehicle is shown to be located. The input commands 310 may be transmitted from the input controller 115 to the feedback controller 130. Once the feedback controller 130 receives the input command 310, the feedback controller 130 may perform one of its functionalities via the output application 230 to forward the input command 315 from the feedback controller 130 to the host 105.

When the feedback controller 130 receives the input command 310, the feedback controller 130 may also perform a processing step via the motion application 225 to determine the action to be performed by the motion platform 125 based upon the input command 310. Accordingly, the feedback controller 130 may transmit the motion data 320 to the motion driver 120. The motion driver 120 may accordingly translate the motion data into commands to control the manner in which the motion platform 125 is to perform the appropriate action.

When the host 105 receives the input command 315, the host 105 may process the input command 315 to update the virtual environment. For example, the host 105 may update the visual and audio components of the virtual environment. If properly configured and the input controller 115 is also capable of a further sensory feature, the host 105 may also process 325 the input command 315 to generate an output signal 330. The output signal 330 may initially be received by the feedback controller 130. Accordingly, the feedback controller 130 may perform the forwarding functionality to forward the output signal 335 to the input controller 115. The input controller 115 may accordingly process the output signal 335 to provide the corresponding further sensory feature.

When the feedback controller 130 receives the output signal 330, the feedback controller 130 may perform a further processing step via the motion application 225 to determine the action to be performed by the motion platform 125 based upon the output signal 330. Accordingly, the feedback controller 130 may transmit the motion data 340 to the motion driver 120. The motion driver 120 may accordingly translate the motion data into commands to control the manner in which the motion platform 125 is to perform the appropriate action.

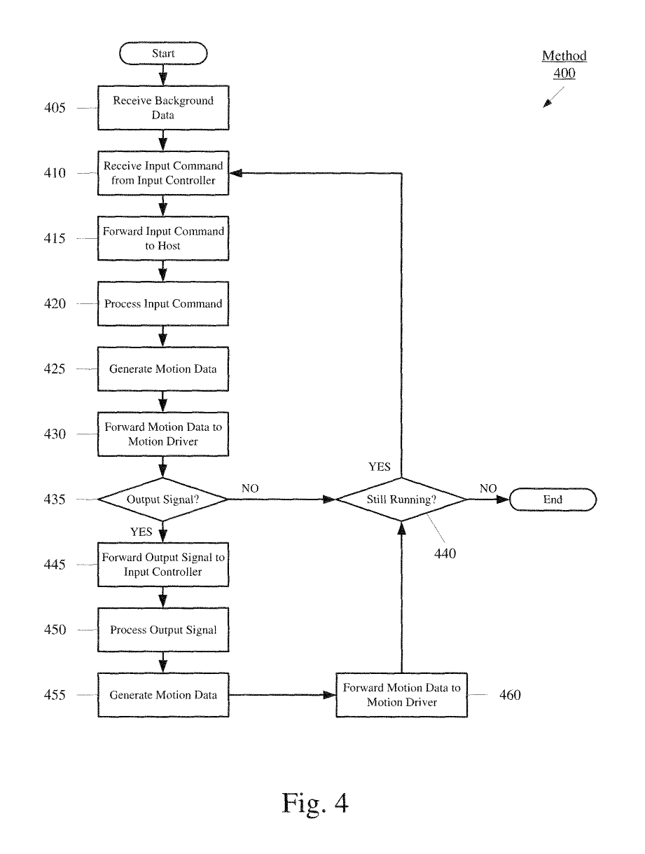

FIG. 4 shows a method 400 for generating motion commands according to the exemplary embodiments. The method 400 relates to a mechanism according to the exemplary embodiments in which components utilizing standard USB connections may be leveraged for use in motion simulation on the motion platform 125. The method 400 will be described with respect to a perspective of the feedback controller 130. As described above, the feedback controller 130 may be disposed in an intermediary position on the signal pathway between the host 105, the input controller 115, and the motion driver 120. The method 400 will also be described with regard to the system 100 of FIG. 1 and the feedback controller 130 of FIG. 2.

In step 405, the feedback controller 130 receives background data. Specifically, the background application 120 may track the background data that is to be used for the current iteration of the simulation. The feedback controller 130 may receive the background data associated with the host 105 and the motion platform 125. The background data associated with the host 105 may relate to the type of virtual environment that is to be created for the user. For example, when the host 105 is a gaming console, the user may select a game and the host 105 may render the virtual environment for the game. The background data may indicate the selected game and associated virtual environment. The background data associated with the motion platform 125 may relate to the types of motions capable to be performed thereon (e.g., number of degrees of freedom).

In step 410, the feedback controller 130 receives an input command from the input controller 115. More specifically, the user may enter a command on a component of the feedback controller 130 such as a steering wheel, a joystick, a directional pad, etc. The input controller 115 may convert the command into the input command. As the input controller 115 utilizes conventional USB signals, the command may be converted to a USB HID input report that corresponds to the command entered by the user.

In step 415, the feedback controller 130 may perform a first one of its functionalities by forwarding the input command received from the input controller 115 to the host 105. Specifically, the output application 230 may receive the input command, recognize that the signal received from the input controller is a type corresponding to an input command, and forward the input command to the host 105. As the input command was generated to be transmitted to the host 105 for the host 105 to update the virtual environment (e.g., visual and audio updates), the input command may be forwarded for proper execution of the simulation.

In step 420, the feedback controller 130 may perform a second one of its functionalities by processing the input command received from the input controller 115 to generate corresponding motion data. Specifically, the motion application 225 may convert the input command into corresponding motion data. As described above, the input command may be a conventional USB HID input report. The feedback controller 130 may be configured to receive the USB HID input report to determine an action that the motion platform 125 is to perform. Specifically, in step 425, the feedback controller 130 may utilize the background data in conjunction with the USB HID input report to generate the motion data. For example, the host 105 may be a flight simulator with the input controller 115 being a control yoke. The user may lower the aircraft in the virtual environment by pivoting the control yoke away from the user. The USB HID input report may include an update to the y-axis and/or the z-axis while the x-axis may remain unchanged. The feedback controller 130 may convert the USB HID input report into the appropriate motion data that is to be used by the motion driver 120. Thus, in step 430, the feedback controller 130 via the output application 230 may forward the motion data to the motion driver.

In step 435, the feedback controller 130 determines whether there is an output signal. As described above, the input controller 115 may include a further sensory component where select types of input commands may trigger activation of the further sensory component. For example, the further sensory component may be a rumble pack that vibrates upon receiving an output signal from the host 105. The output signal may indicate an activation and a duration upon which the vibration is to last. While being in the intermediary position, the feedback controller 130 may receive any output signal from the host 105 that is bound for the input controller 115. If there is no output signal, the feedback controller 130 may continue the method 400 to step 440 to determine whether the simulation is still running. If still running, the feedback controller 130 returns the method 400 to step 410 to receive an ensuing input command. As the same simulation is being run, the background data received in step 405 may be utilized until the simulation is terminated.

If the feedback controller 130 receives an output signal, the feedback controller 130 continues the method 400 to step 445. In step 445, the feedback controller 130 performs the first functionality of forwarding the output signal received from the host 105 to the input controller 115 so that the input controller 115 may perform its functionality of activating the further sensory component.

When the feedback controller 130 receives the output signal, in step 450, the feedback controller 130 may further perform the second functionality of processing the output signal received from the host 105 to generate further corresponding motion data. Specifically, the motion application 225 may convert the output signal into the further corresponding motion data. Since the input controller 115 utilizes a conventional USB connection, the output signal may also be generated as a USB signal. The feedback controller 130 may be configured to receive the output signal to determine an action that the motion platform 125 is to perform. Specifically, in step 455, the feedback controller 130 may utilize the background data in conjunction with the USB HID input report to generate the further motion data. Thus, in step 460, the feedback controller 130 via the output application 230 may forward the further motion data to the motion driver. Subsequently, the feedback controller 130 continues the method 400 to step 440.

It should be noted that the motion application 225 of the feedback controller 130 utilizing only the input command from the input controller 115 and the output signal of the host 105 is only exemplary. The feedback controller 130 may be configured to utilize further types of signals in determining the motion data to be transmitted to the motion driver 120 to control the manner in which the motion platform 125 is to provide the sensory experience for the user. For example, the feedback controller 130 may also be disposed in an intermediary position between the host 105 and the display device 110. In this manner, the signals the host 105 transmits to the display device 110 for the visual and/or audio aspects of the virtual environment may also be received by the feedback controller 130. the feedback controller 130 may thereby also utilize these signals in determining the motion data and rendering the sensory experience for the user on the motion platform 125.

The exemplary embodiments provide a feedback controller that enables conventional USB connections between a host and an input controller to be leveraged for use in controlling a motion platform. The motion platform may utilize any connection that is configured to receive motion data from the feedback controller. In this manner, any COTS components may be used for a virtual simulation environment as the feedback controller may properly convert inputs and outputs into corresponding motion actions on the motion platform.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
receiving, by a feedback controller, an input command from an input controller, the input command corresponding to a command entered by a user, the input controller utilizing a universal serial bus (USB) connection with the feedback controller;
determining, by the feedback controller, motion data corresponding to the input command, the motion data indicating a sensory action to be performed by a motion platform, the motion platform connected to the feedback controller; and
transmitting the motion data from the feedback controller to the motion platform.

2. The method of claim 1, wherein the feedback controller is connected to a host, the host generating a virtual environment associated with the motion platform.

3. The method of claim 2, wherein the virtual environment includes at least one of a visual component and an audio component.

4. The method of claim 2, further comprising:
receiving, by the feedback controller, background data from at least one of the host and the motion platform, the background data indicating a type of the virtual environment being rendered for the user, the background data being utilized to determine the motion data.

5. The method of claim 2, further comprising:
forwarding, by the feedback controller, the input command to the host.

6. The method of claim 2, further comprising:
receiving, by the feedback controller, an output signal from the host, the output signal corresponding to an activation of a sensory component of the input controller;
determining, by the feedback controller, further motion data corresponding to the output signal; and
transmitting the further motion data from the feedback controller to the motion platform.

7. The method of claim 6, further comprising:
forwarding, by the feedback controller, the output signal to the input controller.

8. The method of claim 1, wherein the motion data is transmitted from the feedback controller to a motion driver, the motion driver translating the motion data into corresponding action signals for the motion platform.

9. The method of claim 1, wherein the input command is a USB human interface device (HID) input report.

10. The method of claim 1, wherein the motion platform inclusively includes between one and six degrees of freedom.

11. A feedback controller, comprising:
an input/output (I/O) device receiving an input command from an input controller, the input command corresponding to a command entered by a user, the input controller utilizing a universal serial bus (USB) connection with the feedback controller; and
a processor determining motion data corresponding to the input command, the motion data indicating a sensory action to be performed by a motion platform, the motion platform connected to the feedback controller,
wherein the I/O device transmits the motion data from the feedback controller to the motion platform.

12. The feedback controller of claim 11, wherein the I/O device established a connection to a host, the host generating a virtual environment associated with the motion platform.

13. The feedback controller of claim 12, wherein the virtual environment includes at least one of a visual component and an audio component.

14. The feedback controller of claim 12, wherein the I/O device further receives background data from at least one of the host and the motion platform, the background data indicating a type of the virtual environment being rendered for the user, the processor further utilizing the background data to determine the motion data.

15. The feedback controller of claim 12, wherein the I/O device further forwards the input command to the host.

16. The feedback controller of claim 12, wherein the I/O device receives an output signal from the host, the output signal corresponding to an activation of a sensory component of the input controller, wherein the processor determines further motion data corresponding to the output signal, and the I/O device transmits the further motion data from the feedback controller to the motion platform.

17. The feedback controller of claim 16, wherein the I/O device further forwards the output signal to the input controller.

18. The feedback controller of claim 1, wherein the processor includes a motion driver, the motion driver translating the motion data into corresponding action signals for the motion platform.

19. The feedback controller of claim 11, wherein the input command is a USB human interface device (HID) input report.

20. A non-transitory computer readable storage medium with an executable program stored thereon, wherein the program instructs a microprocessor to perform operations comprising:
receiving an input command from an input controller, the input command corresponding to a command entered by a user, the input controller utilizing a universal serial bus (USB) connection with a feedback controller;
determining motion data corresponding to the input command, the motion data indicating a sensory action to be performed by a motion platform, the motion platform connected to the feedback controller; and
transmitting the motion data from the feedback controller to the motion platform.
